(19) United States
(12) Patent Application Publication
(10) Pub. No.: US 2024/0037060 A1
(43) Pub. Date: Feb. 1, 2024

(54) COMPUTING DEVICE, VIRTUALIZATION ACCELERATION DEVICE, REMOTE CONTROL METHOD AND STORAGE MEDIUM

(71) Applicant: Hangzhou AliCloud Feitian Information Technology Co., Ltd., Hangzhou (CN)

(72) Inventors: Jinkui REN, Hangzhou (CN); Xiantao Zhang, Hangzhou (CN); Binbin WU, Hangzhou (CN); Gan WEN, Hangzhou (CN); Junkang Fu, Hangzhou (CN)

(21) Appl. No.: 18/481,752

(22) Filed: Oct. 5, 2023

Related U.S. Application Data
(63) Continuation of application No. PCT/CN2022/083260, filed on Mar. 28, 2022.

(30) Foreign Application Priority Data
Apr. 6, 2021 (CN) 202110365839.5

(51) Int. Cl. G06F 13/42

(52) U.S. Cl. CPC G06F 13/4282; G06F 2213/3854

(57) ABSTRACT

A virtualization acceleration device is deployed for a physical machine, and a virtualized peripheral controller for the physical machine is implemented on the virtualization acceleration device, so that the physical machine may call the virtualized peripheral controller to execute an operation related to an external device. In this way, a VNC server is deployed on the virtualization acceleration device instead of on the physical machine; the virtualization acceleration device cooperates with a remote control device, and the virtualized peripheral controller remotely controls the physical machine, thereby reducing resources of the physical machine consumed in the remote interaction process, which in turns improves the physical machine performance.

### CROSS REFERENCE TO RELATED APPLICATIONS

This application claims priority to and is a continuation of PCT Patent Application No. PCT/CN2022/083260, filed on 28 Mar. 2022 and entitled “COMPUTING DEVICE, VIRTUALIZATION ACCELERATION DEVICE, REMOTE CONTROL METHOD AND STORAGE MEDIUM,” which claims priority to Chinese Patent Application No. 202110365839.5, filed on 6 Apr. 2021 and entitled “COMPUTING DEVICE, VIRTUALIZATION ACCELERATION DEVICE, REMOTE CONTROL METHOD AND STORAGE MEDIUM,” which are incorporated herein by reference in their entirety.

### TECHNICAL FIELD

The present disclosure relates to the technical field of computer technology, and, more particularly, to computing devices, virtualization acceleration devices, remote control methods, and storage media.

### BACKGROUND

Virtual network computing (VNC) is a system that uses the remote frame buffer (RFB) protocol to enable screen sharing and remote display. The VNC system can transmit keyboard and mouse actions as well as real-time screen images through a network, thus achieving a simple remote interaction.

The VNC system includes two components: a VNC server 204 and a VNC client. The VNC client is installed on a main control device, whereas the VNC server 204 is installed on a controlled device. The VNC client communicates with the VNC server 204 to enable the control of the controlled device remotely. However, the VNC server 204 being directly deployed on the controlled device means consuming the computing, storage, and network resources of the controlled device, which is particularly salient on network resources, thus affecting the physical machine performance.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

Multiple aspects of the present disclosure provide computing devices, virtualization acceleration devices, remote control methods, and storage media for reducing the resources of a physical machine consumed during remote interactions and improving the physical machine performance.

Embodiments of the present disclosure provide a computing device, comprising a physical machine and a virtualization acceleration device; the virtualization acceleration device is connected to the physical machine through a high-speed serial bus; a virtualized peripheral controller for the physical machine is implemented on the virtualization acceleration device, and is configured for cooperating with a remote control device to remotely control the physical machine; the physical machine is configured to identify the virtualized peripheral controller and call the virtualized peripheral controller to execute a peripheral operation, wherein the peripheral operation corresponds to the remote control.

Embodiments of the present disclosure further provide a virtualization acceleration device, comprising a high-speed serial bus and a virtualized peripheral controller for a physical machine; the virtualization acceleration device is connected to the physical machine through the high-speed serial bus; the virtualized peripheral controller is configured to cooperate with a remote control device to remotely control the physical machine, wherein the physical machine calls the virtualized peripheral controller to execute a peripheral operation, and the peripheral operation corresponds to the remote control.

Embodiments of the present disclosure further provide a remote control method, comprising: receiving, by a virtualization acceleration device, a remote control message sent by a remote control device for remotely controlling a physical machine, wherein the virtualization acceleration device is connected to the physical machine through a high-speed serial bus; remotely controlling the physical machine through a virtualized peripheral controller on the virtualization acceleration device according to the remote control message, wherein the physical machine calls the virtualized peripheral controller to execute a peripheral operation, and the peripheral operation corresponds to the remote control.

Embodiments of the present disclosure further provide a computer-readable storage medium having stored therein computer program/instructions, wherein when the computer program/instructions are executed by one or more processors, the one or more processors are enabled to implement steps in the remote control methods provided by the embodiments of the present disclosure.

Embodiments of the present disclosure further provide a computer program product, comprising a computer program/instructions, wherein when the computer program/instructions are executed by one or more processors, the one or more processors are enabled to implement steps in the remote control methods provided by the embodiments of the present disclosure.

In the embodiments of the present disclosure, the virtualization acceleration device is deployed for a physical machine, and a virtualized peripheral controller for the physical machine is implemented on the virtualization acceleration device, so that the physical machine may call the virtualized peripheral controller to execute a peripheral operation. In this way, a VNC server 204 can be deployed on the virtualization acceleration device instead of on the physical machine; the virtualization acceleration device cooperates with a remote control device, and the virtualized peripheral controller remotely controls the physical machine, thereby reducing resources of the physical machine consumed in the remote interaction process, which in turns improves the physical machine performance.

### BRIEF DESCRIPTION OF DRAWINGS

The accompanying drawings described herein are used to further illustrate the present disclosure, and constitute a part thereof. The illustrative embodiments of the present disclosure and the descriptions thereof are used to explain the present disclosure, and do not constitute an improper limitation to the present disclosure. In the drawings:

FIG. 1a is a schematic structural diagram of a computing device provided by an example embodiment of the present disclosure;

FIG. 1B is a schematic structural diagram of another computing device provided by an example embodiment of the present disclosure;

FIG. 1c is a schematic structural diagram of yet another computing device provided by an example embodiment of the present disclosure;

FIG. 1d is a schematic structural diagram of yet another computing device provided by an example embodiment of the present disclosure;

FIG. 2 is an internal architecture diagram of the computing device shown in FIG. 1B when implementing a VNC solution;

FIG. 3 is a schematic structural diagram of yet another computing device provided by an example embodiment of the present disclosure;

FIG. 4 is a schematic structural diagram of a virtualization acceleration device provided by an example embodiment of the present disclosure; and

FIG. 5 is a schematic flow chart of a remote control method provided by an example embodiment of the present disclosure.

### DESCRIPTION OF EMBODIMENTS

In order to make the objectives, technical solutions, and advantages of the present disclosure clearer, the technical solutions of the present disclosure will be clearly and completely described below in combination with the specific embodiments of the present disclosure and the corresponding accompanying drawings. Apparently, the described embodiments only represent some of the embodiments of the present disclosure, but not all the embodiments. All other embodiments obtained by a person of ordinary skill in the art based on the embodiments of the present disclosure without involving an inventive effort fall within the protection scope of the present disclosure.

The existing VNC-based remote interaction solution faces the technical problem that directly deploying the VNC server 204 on the controlled device will reduce the performance of the controlled device. To solve the technical problem, in some embodiments of the present disclosure, a virtualization acceleration device is deployed for a physical machine; the virtualization acceleration device helps to offload some functions of the physical machine. For example, various virtualization functions such as computing, network, and storage can be offloaded to and implemented on the virtualization acceleration device, thus reducing the load and accelerating the physical machine and improving the performance thereof. In addition, the virtualization acceleration device may also be used to provide other services for the physical machine, such as VNC remote interaction. For example, a virtualized peripheral controller for the physical machine is implemented on the virtualization acceleration device, so that the physical machine may call the virtualized peripheral controller to execute an operation related to an external device (referred to as a peripheral operation). In this way, a VNC server 204 can be deployed on the virtualization acceleration device instead of on the physical machine; the virtualization acceleration device cooperates with a remote control device, and the virtualized peripheral controller remotely controls the physical machine, thereby reducing resources of the physical machine consumed in the remote interaction process and further improving the physical machine performance.

The technical solutions provided by various embodiments of the present disclosure will be described in detail below in combination with the accompanying drawings.

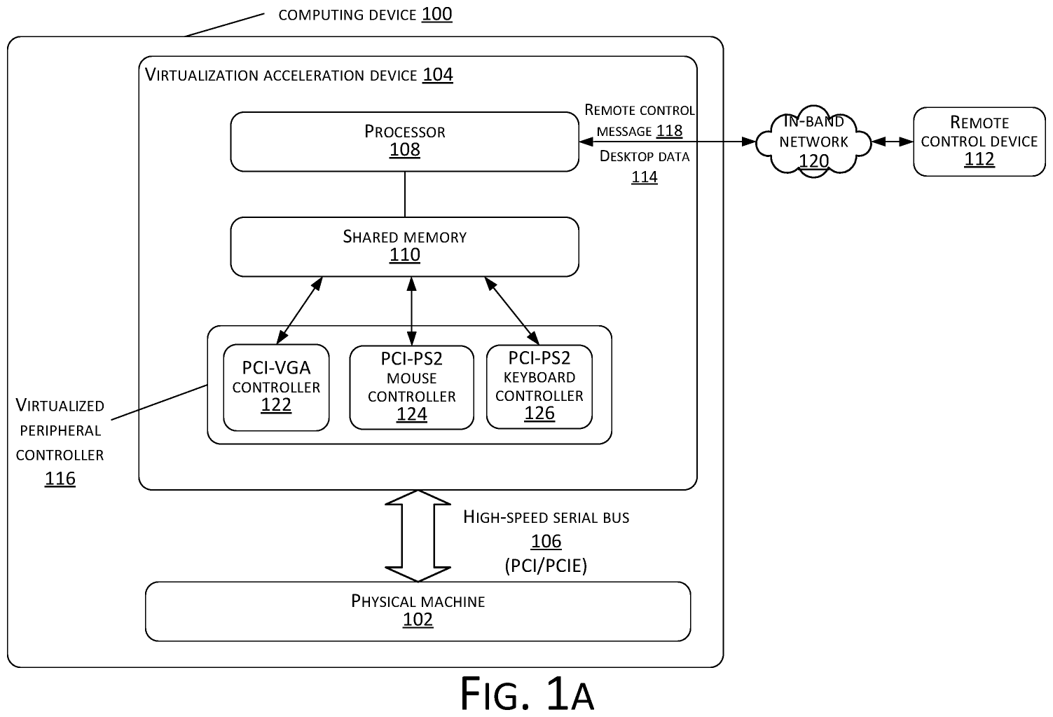

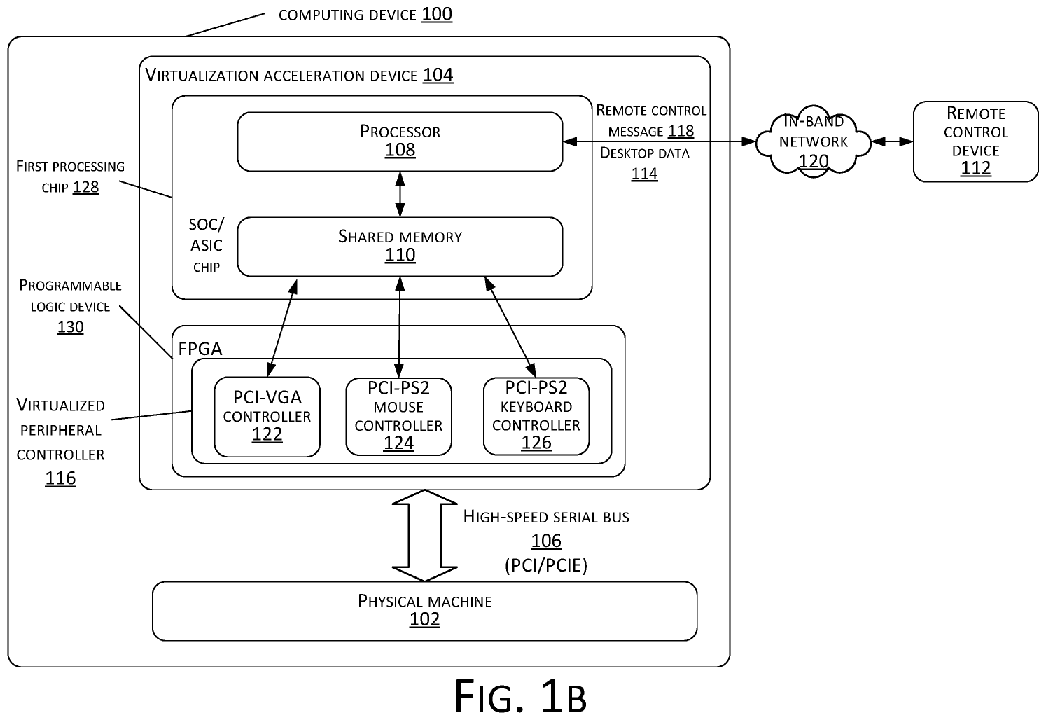

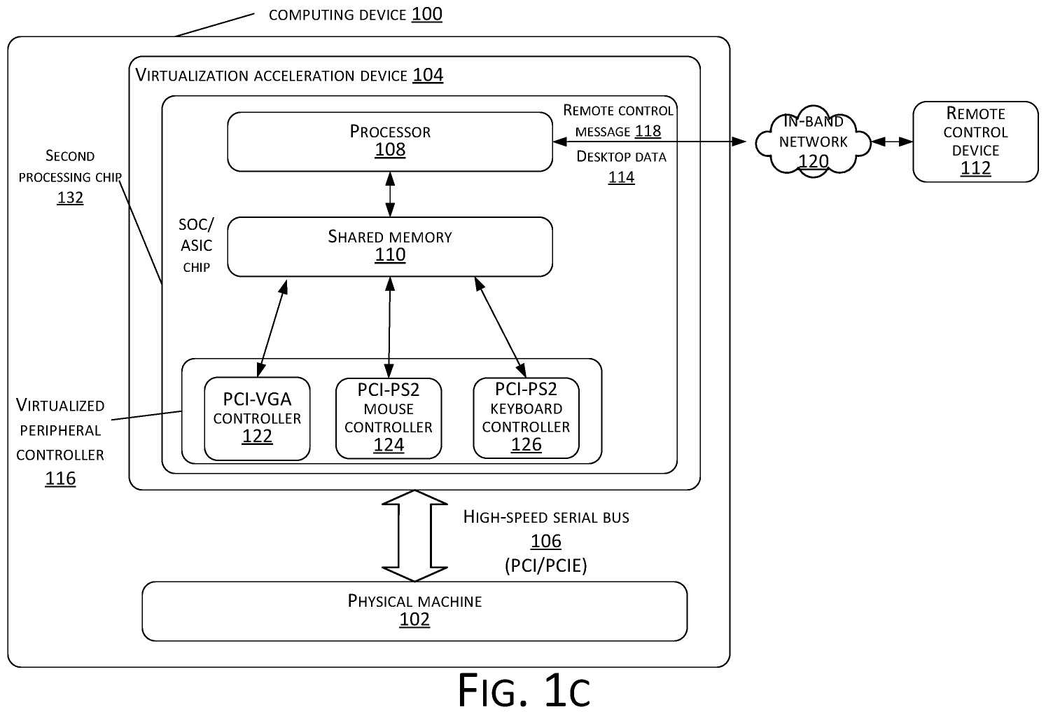

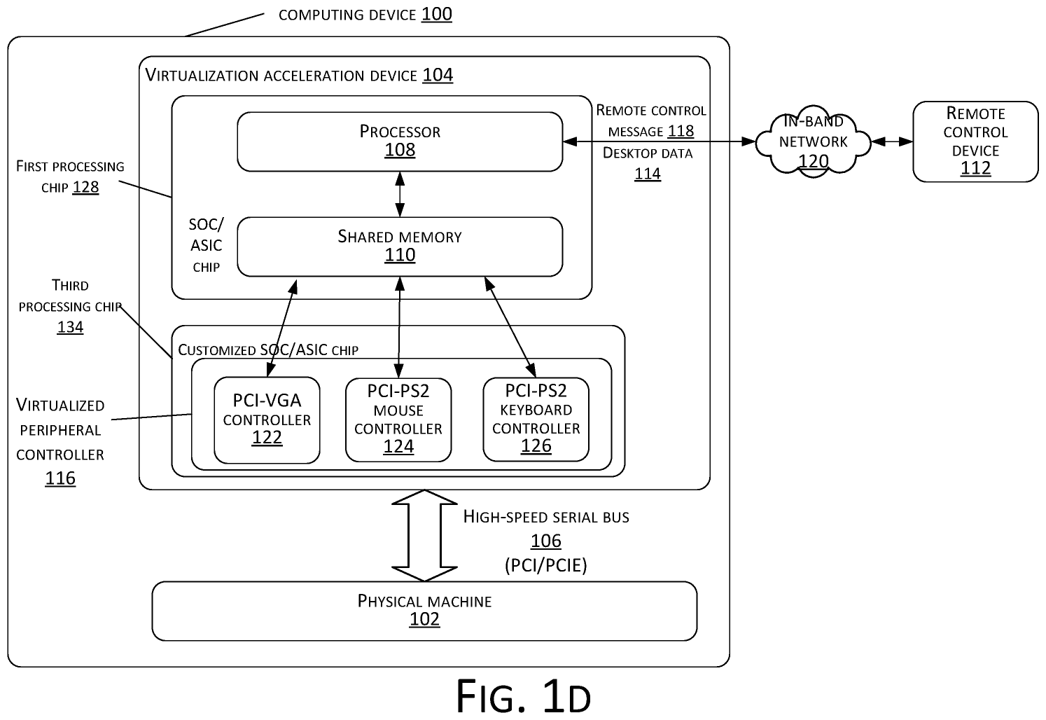

FIG. 1a is a schematic structural diagram of a computing device provided by an example embodiment of the present disclosure. As shown in FIG. 1, the computing device 100 comprises a physical machine 102 and a virtualization acceleration device 104, wherein the virtualization acceleration device 104 is connected to the physical machine 102 through a high-speed serial bus 106.

In this embodiment, the device form of the physical machine 102 is not limited. It can be any physical device with certain capabilities of computing, storage, and communication, such as a desktop computer, a laptop, a smartphone, an IOT device, or other terminal devices, and can also be a conventional server, a host, a server array, or other server devices. In addition, the implementation structure of the physical machine 102 is not limited in this embodiment, which may include internal components such as a processor, a memory, a network card chip, an 10 bus, audio and video components, etc. The physical machine 102 may further include non-volatile storage resources such as hard disks and SSD cards. The physical machine 102 may further include non-volatile storage resources such as hard disks and SSD cards. Certainly, the physical machine 102 may not need to include non-volatile storage resources such as hard disks and SSD cards, and in which case, the virtualization acceleration device 104 is used for virtualizing storage resources to enable the connection with cloud disks, network attached storage (NAS) devices, and other storage resources on the cloud.

In addition to the above-mentioned internal components, the physical machine 102 may further have an operating system (OS), one or more application programs, etc., running thereon, wherein the OS, the application programs, and related program data can be stored in non-volatile storage resources of the physical machine 102 locally or in the cloud storage resources. Further, the physical machine 102 of this embodiment may further include some external devices, such as a keyboard, a mouse, an input pen, a printer, a display, etc. It should be noted that the internal components or external devices included in the physical machine 102, such as audio and video components, displays, etc., may vary depending on the device forms. For example, if the physical machine 102 is a terminal device, then audio and video components, displays, etc., may be included. If the physical machine 102 is a server device, then audio and video components, displays, etc., may not be included.

In this embodiment, the virtualization acceleration device 104 is a device that may implement the virtualization technology and help the physical machine 102 interconnected thereto to implement at least some virtualization functions. That is, the physical machine 102 may offload part or all of the virtualization functions to the virtualization acceleration device 104, thereby achieving performance acceleration. The implementation forms of the virtualization acceleration device 104 are not limited by this embodiment, which can be a board or a chip. As shown in FIG. 1a, the virtualization acceleration device 104 has its own computing resources, such as a processor 108, as well as external interfaces, such as the high-speed serial bus 106. The processor 108 may be a CPU, GPU, ASIC chip, or an SOC chip, which is not limited thereto. For example, the virtualization acceleration device 104 may further have its own storage resources; for example, it may include local storage resources such as memories and hard disks, and may further include cloud storage resources such as cloud disks and NAS. The shared memory 110 as shown in FIG. 1a is part of the memory resources on the virtualization acceleration device 104. Further, the virtualization acceleration device 104 may further have a network card and its own network resources, which are not shown in FIG. 1a. In this embodiment, the virtualization acceleration device 104 adopts a software-hardware integration design, including not only some of the hardware resources mentioned above, but also software resources running on the hardware resources, such as operating systems, software for enabling the virtualization technology, drivers for related hardware, etc. The software for enabling the virtualization technology can be, but not limited to: Hypervisor, also known as Virtual Machine Monitor. Hypervisor is an intermediate software that runs between hardware and operating systems, allowing multiple operating systems and applications to share a set of basic physical resources. Therefore, it can also be regarded as a “meta” operating system in a virtual environment, the core for enabling the virtualization technology.

In this embodiment, the virtualization acceleration device 104 is interconnected to the physical machine 102 through the high-speed serial bus 106, which allows the virtualization acceleration device 104 to be piggybacked on the physical machine 102. On this basis, by virtue of the software and hardware resources of the virtualization acceleration device 104, some or all of the virtualization logic such as computing, storage, and network that is originally implemented on the physical machine 102 can be offloaded to the virtualization acceleration device 104, which not only improves the virtualization performance and reduces costs, such a solution also ensures that the physical machine 102 has the functions of a virtual machine and can be interconnected to cloud disks and VPC networks just like a virtual machine. In addition, it is ensured that the physical machine 102 uses its own computing, storage, and other resources independently, eliminating the issue of multiple virtual machines sharing local resources of the physical machine, and thus turning the physical machine 102 into a computing device having both the resilience from a virtual machine and the performance from a physical machine. In this way, the physical machine 102 is highly isolated, and has both the migration advantages of the virtual machine and the resilient advantage of cloud deployment. In addition, it has the advantages of supporting rapid delivery, compatible virtual machine mirroring, cloud storage device startup, attachment of cloud storage devices, migration recovery of physical machine failures, automated operation and maintenance, etc., thus having high application value.

The high-speed serial bus 106 includes, but is not limited to: a peripheral component interconnect (PCI) bus, a peripheral component interconnect express (PCIE) bus. The virtualization acceleration device 104 is interconnected to the physical machine 102 through the high-speed serial bus 106, which ensures the reliable and efficient information transmission therebetween, providing conditions for offloading some or all of the logic of virtualization implemented on the physical machine 102, such as computing, storage, and network, to the virtualization acceleration device 104. Certainly, the virtualization acceleration device 104 may further be interconnected to the physical machine 102 in other ways, such as internetworking.

In this embodiment, the remote control device 112 may remotely log into the physical machine 102 and perform various controls on the physical machine 102, such as controlling the power on and off of the physical machine 102, opening application programs on the physical machine 102, remotely viewing files on the physical machine 102, sending and receiving emails, scheduling work, etc., so that the physical machine 102 provides the same user experience as the virtual machine. Controlling the physical machine 102 remotely needs to be performed as if the physical machine 102 is operated locally; and controlling the physical machine 102 locally needs to be performed through some external devices of the physical machine 102. For example, to open an application program on the physical machine 102, a mouse of the physical machine 102 is required to perform a double-click on an application icon on the desktop; to send and receive emails on the physical machine 102, a mouse of the physical machine 102 is required to click on the email editing controls on the interface; to enter email content, a keyboard of the physical machine 102 is required, etc. It can be seen that the controlling of the physical machine 102 by the remote control device 112 is actually a process of transmitting the control actions of some external devices such as the mouse and keyboard at the local side of the remote control device 112 to the side of the physical machine 102, and simulating the relevant operations at the physical machine 102 based on these control actions. Further, when the physical machine 102 is provided with a display, the remote control device 112 may further synchronize the desktop data 114 of the physical machine 102 to the local end of the remote control device 112 during the remote control process of the physical machine 102, providing conditions for the control operation of the physical machine 102. The physical machine 102 needs to be able to identify the corresponding control actions transmitted from the side of the remote control device 112, which is also the key to ensure successful remote control.

In this embodiment, the functions related to remote control are offloaded from the physical machine 102 to the virtualization acceleration device 104, saving the consumption of various resources on the physical machine 102 for the remote control process, and in particular, saving the network resources of the physical machine 102. For example, as shown in FIG. 1a, the virtualized peripheral controllers 116 for the physical machine 102 are implemented on the virtualization acceleration device 104, wherein the virtualized peripheral controllers 116 are implemented as hardware; the physical machine 102, through a high-speed serial bus 106 with the virtualization acceleration device 104, may identify the virtualized peripheral controllers 116 implemented on the virtualization acceleration device 104, and call these virtualized peripheral controllers 116 to execute operations related to external devices (i.e., peripheral operations). These virtualized peripheral controllers 116 are similar to the built-in peripheral controllers of the physical machine 102, which can capture the actions of corresponding external devices on the physical machine 102, monitor the status of the external devices, execute the operations related to the external devices, or process data related to the external devices. Among them, the peripheral controllers corresponding to different external devices will differ in the functions they implement and the peripheral operations performed after being called by the physical machine 102. Examples are illustrated as follows.

If the external device is an input device, such as a mouse, keyboard, or touch screen, the corresponding virtualized peripheral controller 116 is mainly configured to capture actions of the mouse, keyboard, or touch screen, track the status of the mouse, keyboard, or touch screen, and report the acquired action information or the tracked status information to the physical machine 102, specifically to the operating system of the physical machine 102; and the operating system calls a driver of the mouse, keyboard, or touch screen to perform corresponding processing.

If the external device is an output device, such as a display, the corresponding virtualized peripheral controller 116 is mainly configured to receive to-be-displayed desktop data 114 provided by the physical machine 102 and perform display-related processing on the desktop data 114, such as rendering, outputting, etc.

As the virtualized peripheral controllers 116 implemented on the programmable logic device 130 may learn and participate in the related operations of the physical machine 102, the virtualization acceleration device 104 can cooperate with the remote control device 112 to remotely control the physical machine 102 through these Virtualized peripheral controllers 116. As shown in FIG. 1a, the remote control device 112 may send a remote control message 118 to the virtualization acceleration device 104 through a network such as an in-band network 120, wherein the remote control message 118 may vary depending on remote control requirements; and then, after receiving the remote control message 118, the processor 108 on the virtualization acceleration device 104 may remotely control the physical machine 102 through the virtualized peripheral controller 116 according to the remote control message 118. In this embodiment, the remotely controlling the physical machine 102 is achieved through the cooperation of the processor 108 on the virtualization acceleration device 104 and the virtualized peripheral controller 116; and the virtualized peripheral controller 116 is a hardware implementation, which means that the remotely controlling the physical machine 102 through the virtualized peripheral controller 116 is a combination of software and hardware implementation, different from the remote control using merely software logic.

In some example embodiments of the present disclosure, the virtualization acceleration device 104 may be interconnected to the physical machine 102 using PCI or PCIE. Compared to the physical machine 102, the virtualization acceleration device 104 can be regarded as a PCI or PCIE device mounted on the physical machine 102. Therefore, the virtualization acceleration device 104 has its own PCI or PCIE configuration space, which is used to store some description information of the virtualization acceleration device 104, such as the vendor ID, device ID, class code, interrupt pins, and other important information. On this basis, the process of implementing the virtualized peripheral controller 116 on the virtualization acceleration device 104 specifically includes: configuring registers required for the peripheral controller on the virtualization acceleration device 104, and mapping the registers to a PCI or PCIE configuration space of the virtualization acceleration device 104 to implement the virtualized peripheral controller 116.

Based on the above, the process that the physical machine 102 identifies the virtualized peripheral controller 116, for example, includes: enumerating devices on the high-speed serial bus, wherein enumeration refers to the process of traversing all devices mounted on the high-speed serial bus and acquiring information in the configuration space corresponding to the traversed devices. Throughout the entire process, the physical machine 102 may obtain detailed information about each device mounted on the high-speed serial bus according to the information in the configuration space of each traversed device. For example, the physical machine 102 may enumerate the devices on the high-speed serial bus according to a specified time period, which can be 1 second, 1 minute, 1 hour, etc.; and the physical machine may also enumerate the devices on the high-speed serial bus every time it is powered on. In this embodiment, the virtualization acceleration device 104 can be identified first; further, if the virtualization acceleration device 104 is discovered, the virtualized peripheral controllers 116 implemented on the virtualization acceleration device 104 can be identified based on the values of at least some of the registers in its configuration space, and the driver of the virtualized peripheral controllers 116 are started. The at least some of the registers can be some registers of the Virtualized peripheral controllers 116 or can be all registers of the Virtualized peripheral controllers 116, which is not limited thereto. The at least some registers for identifying the virtualized peripheral controllers 116 can be registers that record the vendor ID, registers that record the device ID, registers that record the device status, etc.

In an example embodiment, the physical machine 102 is provided with an external input device; the virtualized peripheral controller 116 implemented on the virtualization acceleration device 104 then may include a first peripheral controller corresponding to the external input device. In this example embodiment, the remote control device 112 may remotely control the physical machine 102 in relation to the external inputs, so it may send, to the virtualization acceleration device 104, a remote control message 118, which includes control actions related to the external inputs. After receiving the remote control message 118, the processor 108 on the virtualization acceleration device 104 provides the remote control message 118 to the first peripheral controller; the first peripheral controller reports the remote control message 118 to the physical machine 102 through a PCI or PCIE bus. For the physical machine 102, specifically the operating system on the physical machine 102, operations related to the external input devices can be executed according to the remote control message 118 reported by the first peripheral controller, such as identifying input instructions and performing operations based on the input instructions, such as page opening, page jumping, file opening, or information input.

In this embodiment, the manner in which the processor 108 provides the remote control message 118 to the first peripheral controller is not limited. In an example embodiment, as shown in FIG. 1a, the virtualization acceleration device 104 further includes a shared memory 110. The shared memory 110 can be shared by the first peripheral controller and the processor 108, which means that both the processor 108 and the virtualized peripheral controller 116 may perform read and write operations on the shared memory 110. On this basis, the processor 108 can write the remote control message 118 sent by the remote control device 112 into the shared memory 110, and the first peripheral controller can read the remote control message 118 from the shared memory 110. In another example embodiment, the processor 108 can also provide the remote control message 118 to the first peripheral controller by means of direct memory access (DMA).

For example, the external input device of the physical machine 102 may include at least one of a keyboard, a mouse, and a touch screen. Depending on the external input devices, the first peripheral controller may also vary; and accordingly, the physical machine 102 may perform different operations related to the external input device according to the remote control message 118 reported by the first peripheral controller. Examples are illustrated as follows.

If the external input device is a keyboard, the first peripheral controller can be implemented as a PCI- or PCIE-based keyboard controller; further, for example, if the keyboard is connected to the physical machine 102 using a PS2 interface, the PCI- or PCIE-based keyboard controller can be implemented as a PCI- or PCIE-based PS2 keyboard controller, referred to as a PCI/PCIE-PS2 keyboard controller. The PCI-PS2 keyboard controller 126 is used as an example for illustration in FIG. 1a. In this example, the remote control device 112 may remotely control the physical machine 102 through a keyboard. For example, the remote control device 112 can send a keyboard event as a remote control message 118 to the virtualization acceleration device 104; after receiving the keyboard event, the processor 108 on the virtualization acceleration device 104 provides the keyboard event to the PCI- or PCIE-based keyboard controller, such as a PCI/PCIE-PS2 keyboard controller, by means of the shared memory 110 or DMA; the PCI- or PCIE-based keyboard controller reports the keyboard event to the physical machine 102 through a PCI or PCIE bus; the physical machine 102 parses keyboard codes from the keyboard event; corresponding keys are determined according to the keyboard codes, and a keyboard input operation corresponding to the key is simulated, thereby completing the remote input control on the physical machine 102. As the input to the physical machine 102 is remotely controlled, various operations related to keyboard inputs such as modifying text content, editing emails, inputting search terms, renaming files, etc., can be remotely performed on the physical machine 102.

If the external input device is a mouse, the first peripheral controller can be implemented as a PCI- or PCIE-based mouse controller; further, for example, if the mouse is connected to the physical machine 102 using a PS2 interface, the PCI- or PCIE-based mouse controller can be implemented as a PCI- or PCIE-based PS2 mouse controller, referred to as a PCI/PCIE-PS2 mouse controller. The PCI-PS2 mouse controller 124 is used as an example for illustration in FIG. 1a. In this example, the remote control device 112 may remotely control the physical machine 102 through a mouse. For example, the remote control device 112 may send a mouse event as the remote control message 118 to the virtualization acceleration device 104; after receiving the mouse event, the processor 108 on the virtualization acceleration device 104 provides the mouse event to the PCI- or PCIE-based mouse controller, such as a PCI/PCIE-PS2 mouse controller, by means of the shared memory 110 or DMA; the PCI- or PCIE-based mouse controller reports the mouse event to the physical machine 102 through a PCI or PCIE bus. The physical machine 102 parses the mouse position and mouse click information from the mouse event, wherein the mouse position refers to a cursor position corresponding to the mouse, and the mouse click information can be information indicating the type of a mouse click, such as a single click, a double click, a combo click, a long press, or a right click. Then, a mouse click operation is executed according to the mouse position and the mouse click information, thereby completing the remote mouse control on the physical machine 102. As the mouse of the physical machine 102 is remotely controlled, various operations related to mouse inputs such as opening or closing text folders/files, opening or closing application programs, clicking on interactive controls on various pages, selecting or dragging related content can be remotely performed on the physical machine 102.

In an example embodiment, the physical machine 102 is provided with not only an external input device, but also an external output device; the virtualized peripheral controller 116 implemented on the virtualization acceleration device 104 may then include a second peripheral controller corresponding to the external output device. In this example embodiment, the remote control device 112 can perform remote control related to external outputs on the physical machine 102, so it may send, to the virtualization acceleration device 104, a remote control message 118, which includes control actions related to the external outputs. After receiving the remote control message 118, the processor 108 on the virtualization acceleration device 104 can read, from a memory of the second peripheral controller, target data output by the external output device according to the remote control message 118; and the target data is provided to the remote control device 112 to be output locally thereby, thus achieving synchronizing remote output information.

Further, for example, the processor 108 may directly send all the target data to the remote control device 112, such that the remote control device 112 may directly output the latest target data. Alternatively, before sending the target data to the remote control device 112, the processor 108 may first write the target data into the shared memory 110 on the virtualization acceleration device 104 temporarily; then the target data is analyzed so that part of the data that has changed may be identified; and the part of data is sent to the remote control device 112 such that the remote control device 112 may update the target data to be locally output. This saves network resources as by transmitting only the incremental data that has changed each time, less data is involved.

For example, the external output device of the physical machine 102 may include at least one of a display, a speaker, or the like. Depending on the external output devices, the second peripheral controller may come in different forms and the remote control message 118 will also be different. In what follows a display being the external output device is used as an example for illustration.

If the external output device is a display, the second peripheral controller may be implemented as a PCI- or PCIE-based display controller. Further, for example, if the display adopts the video graphics array (VGA) display standard, the PCI- or PCIE-based display controller may be implemented as a PCI- or PCIE-based VGA controller, referred to as a PCI/PCIE-VGA controller. The PCI-VGA controller 122 is used as an example for illustration in FIG. 1a. For the physical machine 102, when a PCI- or PCIE-based display controller (such as a PCI/PCIE-VGA controller) is identified, a PCI- or PCIE-based display controller can also be called for desktop data 114 display processing. For example, when the upper layer application running on the physical machine 102 needs to perform page display, the desktop data 114 can be sent to the operating system of the physical machine 102, and the operating system calls the PCI- or PCIE-based display controller. The display controller performs desktop data 114 display processing, such as rendering and output, and at the same time, it writes the desktop data 114 into a local memory for storage.

Based on the above, the remote control device 112 may perform remote desktop control on the physical machine 102. For example, the remote control device 112 can send a remote desktop request as a remote control message 118 to the virtualization acceleration device 104. After receiving the remote desktop request, the processor 108 of the virtualization acceleration device 104 reads the desktop data 114 from the memory (usually referred to as video memory) of the PCI- or PCIE-based display controller, such as a PCI/PCIE-VGA controller, and returns the desktop data 114 to the remote control device 112, such that the desktop data 114 may be displayed locally by the remote control device 112, thus completing the remote desktop control on the physical machine 102.

In the embodiments of the present disclosure, how the hardware structure of the virtualization acceleration device 104 is implemented is not limited. For example, the virtualization acceleration device 104 may be implemented as a pluggable board structure, as shown in FIG. 1B and FIG. 1c. Further, as shown in FIG. 1B, the virtualization acceleration device 104 implemented as a board includes a first processing chip 128 and a programmable logic device 130. The programmable logic device 130 can be a field-programmable gate array (FPGA) as shown in FIG. 1B or a complex programmable logic device (CPLD), and the like. The first processing chip 128 can be an ASIC chip or an SOC chip as shown in FIG. 1B. As shown in FIG. 1B, the processor 108 and the shared memory 110 are implemented on the first processing chip 128; and the virtualized peripheral controller 116 is implemented on the programmable logic device 130. As shown in FIG. 1B, the programmable logic device 130 being the FPGA is used as an example for illustration, and a PCI-VGA controller 122, a PCI-PS2 mouse controller 124, and a PCI-PS2 keyboard controller are implemented on the FPGA. The process of implementing the virtualized peripheral controller 116 on the programmable logic device 130, such as the FPGA, mainly includes: registers required for these Virtualized peripheral controllers 116 are implemented on the programmable logic device 130, and the processor 108 maps these registers to the PCI or PCIE configuration space of the virtualization acceleration device 104.

Alternatively, as shown in FIG. 1c, the virtualization acceleration device 104 includes a second processing chip 132; the processor 108, the shared memory 110, and the virtualized peripheral controller 116 are all implemented on the second processing chip 132. For example, the second processing chip 132 may be an ASIC chip or an SOC chip. As shown in FIG. 1c, the SOC chip being the second processing chip 132 is used as an example for illustration. The process of implementing the virtualized peripheral controller 116 on the virtualization acceleration device 104, mainly includes: registers required for these Virtualized peripheral controllers 116 are implemented on the second processing chip 20, and the processor 108 maps these registers to the PCI or PCIE configuration space of the virtualization acceleration device 104. In the embodiment shown in FIG. 1c, the second processing chip 132 may be customized, such as a customized ASIC chip or SOC chip.

Alternatively, as shown in FIG. 1d, the virtualization acceleration device 104 may include a first processing chip 128 and a third processing chip 134. The first processing chip 128 may be an ASIC chip or an SOC chip; the third processing chip 134 may be customized, such as a customized ASIC chip or SOC chip. As shown in FIG. 1d, the processor 108 and the shared memory 110 are implemented on the first processing chip 128; and the virtualized peripheral controller 116 is implemented on the third processing chip 134. As shown in FIG. 1d, a PCI-VGA controller 122, a PCI-PS2 mouse controller 124, and a PCI-PS2 keyboard controller 126 are implemented on the third processing chip 134. The process of implementing the virtualized peripheral controller 116 on the third processing chip 134, mainly includes: registers required for these Virtualized peripheral controllers 116 are implemented on the third processing chip 134, and the processor 108 maps these registers to the PCI or PCIE configuration space of the virtualization acceleration device 104.

In the embodiments of the preset application, taking the PCI-VGA controller 122 as an example, the required registers include, but are not limited to, the following: mixed output registers, feature control registers, input status registers, VGA enable registers, CRT control index registers, CRT control data registers, graphic control index registers, graphic control data registers, attribute controllers, DAC interface registers, etc. Taking the PCI-PS2 keyboard or mouse controller as an example, the required registers include, but are not limited to, read/write data port registers, read status registers, and write command registers.

It should be noted that based on the programmable logic device 130, the second processing chip 132, or the third processing chip 134 mentioned above, hardware modules or devices of various functions can be implemented on the virtualization acceleration device 104 as needed. For example, the hardware modules or devices required for the virtualization acceleration device 104 can be implemented, and other hardware modules or devices required for the physical machine 102 can also be implemented, which are not limited to the virtualized peripheral controllers. In addition, as can be seen from FIG. 1B-FIG. 1d, the virtualized peripheral controller 116 in this embodiment is implemented as hardware.

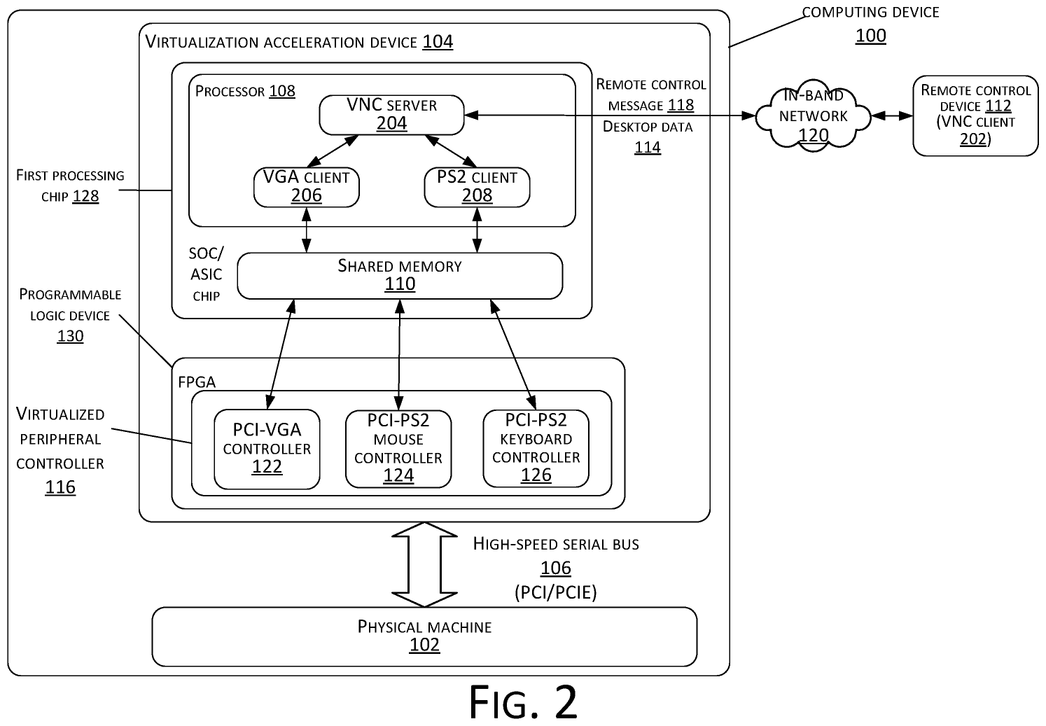

It should be noted that the remote control process implemented by the cooperation of the remote control device 112, the virtualization acceleration device 104, and the physical machine 102 may be implemented using VNC technology, but is not limited thereto. When the VNC technology is used for implementation, the VNC client 202 is deployed on the remote control device 112, and the VNC server 204 is deployed on the virtualization acceleration device 104 instead of the physical machine 102, shown in FIG. 2. The processor 108 runs the VNC server 204 to cooperate with the VNC client 202 running on the remote control device 112, thereby completing the controlling the physical machine 102 remotely by virtue of the virtualized peripheral controller 116. Further, in order to facilitate the interaction between the processor 108 and the virtualized peripheral controller 116, the client software (such as a VGA client 206 and a PS2 client 208 shown in FIG. 2) corresponding to the virtualized peripheral controller 116 can also be developed and installed on the virtualization acceleration device 104; the processor 108 runs the client software corresponding to the virtualized peripheral controller 116 to achieve the interaction with the virtualized peripheral controller 201. The working principle of the computing device shown in FIG. 2 is as follows:
the VNC client 202 sends a remote control message 118 to the VNC server 204 through an in-band network; after receiving the remote control message 118, the VNC server 204 identifies the content contained in the remote control message 118;
if it is identified that the remote control message 118 only includes a keyboard event and/or a mouse event, the VNC server 204 calls the PS2 client to write the keyboard event and/or the mouse event into the shared memory; the PCI/PCIE-PS2 keyboard and/or mouse controller reads the keyboard event and/or mouse event from the shared memory and reports to the operating system of the physical machine through the PCI/PCIE bus; the operating system calls the corresponding driver to execute keyboard input and/or mouse click operations;
if it is identified that the remote control message 118 includes not only the keyboard event and/or the mouse event, but also a remote desktop request, on the one hand, the VNC server 204 calls the PS2 client to write the keyboard event and/or the mouse event into the shared memory; the PCI/PCIE-PS2 keyboard and/or the mouse controller reads the keyboard event and/or the mouse event from the shared memory and reports to the operating system of the physical machine through the PCI/PCIE bus; the operating system calls the corresponding driver to execute keyboard input and/or mouse click operations; on the other hand, the VNC server 204 calls the VGA client to read the desktop data 114 of the physical machine from the video memory of the PCI/PCIE-VGA controller and returns the desktop data 114 to the VNC client 202; the VNC client 202 displays the desktop data 114 of the physical machine on the local display; the desktop data 114 includes static data and dynamic process information of the physical machine performing keyboard input and/or mouse click operations in response to the keyboard event and/or the mouse event.

In the above embodiment of the present disclosure, the VGA controller and the PS2 controller are virtualized on the virtualization acceleration device, the physical machine identifies and uses the VGA controller and the PS2 controller, the VGA client can acquire desktop data 114 from the video memory of the VGA controller and submits the same to the VNC server 204. The VNC client 202 can send the keyboard event and/or mouse event to the PS2 mouse and/or keyboard controller through the PS2 client, and ultimately send the keyboard event and/or mouse event to the PS2 driver in the physical machine, thereby implementing controlling the physical machine remotely. The entire VNC process does not rely on the baseboard management controller (BMC) on the physical machine, or on private components developed by the physical machine vendor for interacting with the BMC, such as jviewer and iKVM components. Moreover, the virtualized peripheral controller directly interacts with the physical machine through the PCI or PCIE bus, and does not rely on the out of band (OOB) data transmission protocol to interact with the BMC on the physical machine. In other words, the virtualization acceleration device according to the embodiments of the present disclosure can be used on all kinds of the physical machines provided by various vendors. When VNC is used, there is no need to acquire the desktop data 114 from the BMC of the physical machine or send the mouse/keyboard events to the BMC, avoiding the interaction with the private components jviewer/iKVM of the vendors, saving the workload of adapting to the private components of the vendors, making it more versatile.

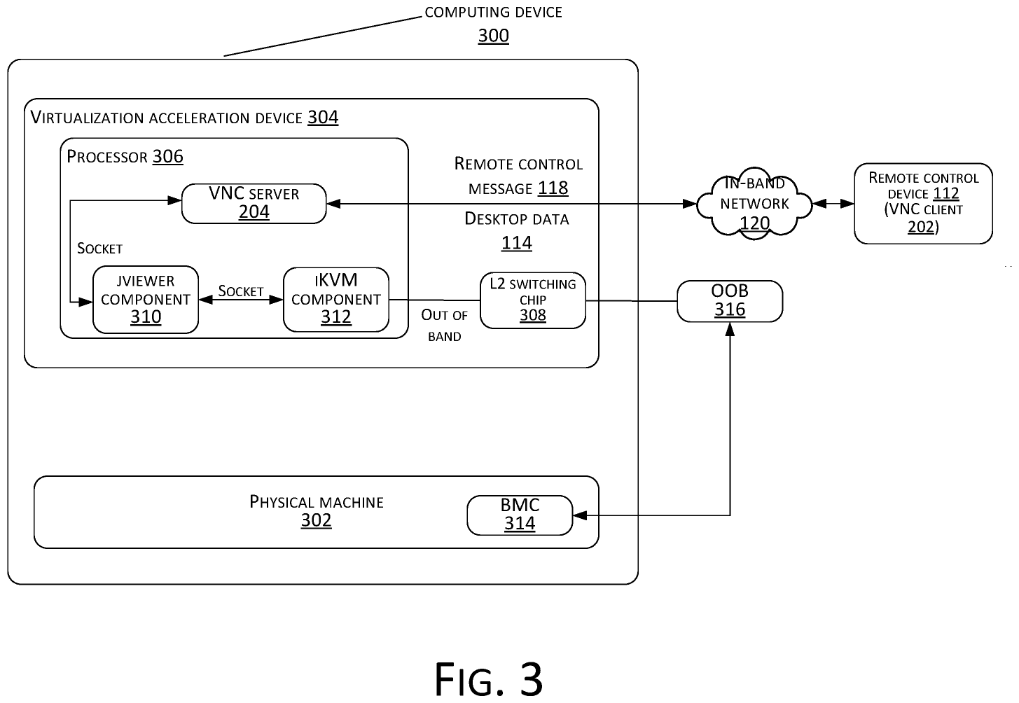

It should be noted that the physical machine according to the embodiments of the present disclosure can use the virtualization acceleration device 104 provided by the embodiments shown in FIG. 1a-FIG. 1d, or FIG. 2, but is not limited thereto. In other embodiments of the present disclosure, the VNC solution may also use another virtualization acceleration device adapted to the private components jviewer/iKVM provided by the physical machine vendor to remotely control the physical machine. The use of the virtualization acceleration device for the physical machines can be flexibly selected or customized by the physical machine vendor based on application requirements. The structure of another computing device provided by other embodiments of the present disclosure and the process of using another virtualization acceleration device to remotely control the physical machine will be described below with reference to FIG. 3.

FIG. 3 is a schematic structural diagram of another computing device provided by other embodiments of the present disclosure. As shown in FIG. 3, the computing device 300 includes a physical machine 302 and a virtualization acceleration device 304. Reference may be made to the aforementioned embodiments for the relevant description of the physical machine 302, details of which will not be repeated herein.

In this embodiment, description is focused on the introduction of the virtualization acceleration device 304. The virtualization acceleration device 304 has its own computing resources, such as a processor 306, and may also have an L2 switching chip 308. The processor 306 may be a CPU, GPU, ASIC chip, or an SOC chip, which is not limited thereto. For example, the virtualization acceleration device 304 may further have its own storage resources; for example, it may include local storage resources such as memories and hard disks, and may further include cloud storage resources such as cloud disks and NAS.

In this embodiment, the virtualization acceleration device 304 adopts a software-hardware integration design, including not only some of the hardware resources mentioned above, but also software resources running on the hardware resources, such as an operating system, an analog processor QEMU, private components such as jviewer component 310 and iKVM component 312 from the physical machine vendors, etc.

In this embodiment, the remote control device 112 may remotely control the physical machine 302 through the virtualization acceleration device 304. For example, the VNC client 202 is deployed on the remote control device 112; the VNC server 204 is deployed on the QEMU on the virtualization acceleration device 304; and the VNC server 204 runs on the QEMU, which provides the VNC client 202 with the same usage as the virtual machine. The VNC client 202 and the VNC server 204 cooperate with the private components including a jviewer component 310 and a iKVM component 312 from the physical machine vendor, as well as the BMC 314 on the physical machine 302, thus achieving controlling the physical machine remotely. The remote control process is as follows:
the VNC client 202 sends a remote control message 118 to the VNC server 204; after receiving the remote control message 118 sent by the VNC client 202, the VNC server 204 identifies the content contained in the remote control message 118;
if it is identified that the remote control message 118 only includes a keyboard event and/or a mouse event, the VNC server 204 communicates with jviewer through a socket and sends to jviewer the keyboard event and/or the mouse event that the VNC client 202 sent; jviewer sends to iKVM the mouse/keyboard events received from the VNC server 204 and eventually sends the mouse/keyboard events to the BMC on the physical machine through out of band (OOB 316); the BMC performs keyboard input and/or mouse click operations;
if it is identified that the remote control message 118 includes not only a keyboard event and/or a mouse event, but also a remote desktop request, the VNC server 204 then communicates with jviewer through a socket. On the one hand, the VNC server 204 sends to jviewer the keyboard event and/or the mouse event sent by the VNC client 202; jviewer sends the mouse/keyboard events received from the VNC server 204 to iKVM and eventually sends the mouse/keyboard events to the BMC on the physical machine through out of band (OOB); the BMC performs keyboard input and/or mouse click operations; and on the other hand, jviewer acquires, from the BMC, desktop data 114 on the VGA audio and video interface of the physical machine through iKVM and submits the desktop data 114 to the VNC server 204. The VNC server 204 returns the desktop data 114 to the VNC client 202 through the in-band network, such that the VNC client 202 displays the desktop data 114 of the physical machine on the local display; the desktop data 114 includes static data and dynamic process information of the BMC performing keyboard input and/or mouse click operations in response to the keyboard event and/or mouse event.

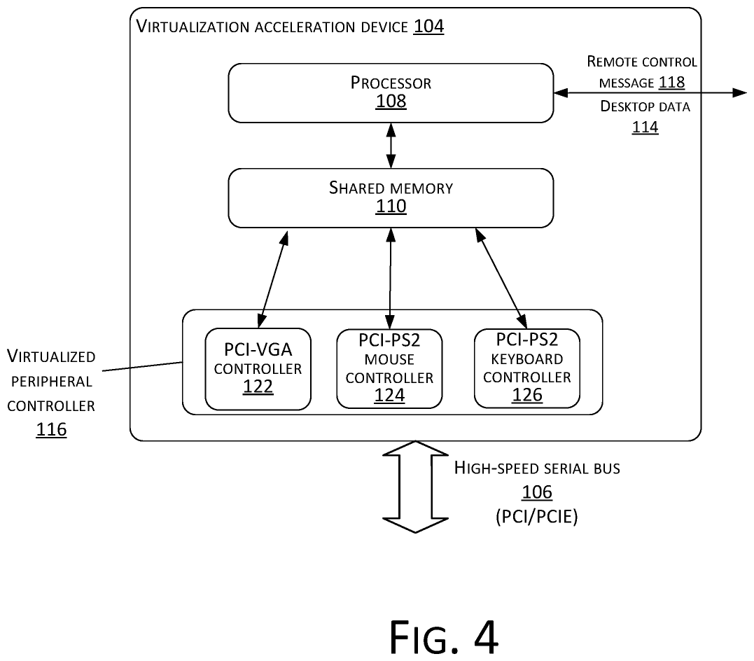

In addition to the above-mentioned computing device, the embodiments of the present disclosure further provide a virtualization acceleration device 104. The virtualization acceleration device 104 is a device that implements the virtualization technology and helps the physical machine interconnected thereto to implement at least part of virtualization functions. That is, the physical machine may offload part or all of the virtualization functions to the virtualization acceleration device 104, thereby achieving performance acceleration. The implementation forms of the virtualization acceleration device 104 are not limited by this embodiment, which can be a board or a chip. As shown in FIG. 4, the virtualization acceleration device 104 has its own computing resources, such as a processor 108, which may be a CPU, GPU, ASIC chip, SOC chip, etc., and is not limited thereto. At the same time, the virtualization acceleration device 104 may further be provided with an external interface, such as a high-speed serial bus 106, which might be, but not limited to, a PCI or PCIE bus. The virtualization acceleration device 104 is interconnected to the physical machine through the high-speed serial bus 106, which ensures reliable and efficient information transmission therebetween.

For example, the virtualization acceleration device 104 may further have its own storage resources; for example, it may include local storage resources such as memories and hard disks, and may further include cloud storage resources such as cloud disks and NAS. The shared memory 110 as shown in FIG. 4 is part of the memory resources on the virtualization acceleration device 104. Further, the virtualization acceleration device 104 also has a network card and its own network resources, which are not shown in FIG. 4.

In this embodiment, the virtualization acceleration device 104 adopts a software-hardware integration design, including not only some of the hardware resources mentioned above, but also software resources running on the hardware resources, such as operating systems, software for enabling the virtualization technology, drivers for related hardware, etc. The software used for implementing the virtualization technology can be, but is not limited to: Hypervisor.

In this embodiment, the virtualization acceleration device 104 is interconnected to the physical machine through the high-speed serial bus 106, which allows the virtualization acceleration device 104 to be piggybacked on the physical machine. On this basis, by virtue of the software and hardware resources of the virtualization acceleration device 104, some of the virtualization logic such as computing, storage, and network that was originally implemented on the physical machine can be offloaded to the virtualization acceleration device 104, which not only improves the virtualization performance and reduces costs, such a solution also ensures that the physical machine has the functions of a virtual machine and can be interconnected to cloud disks and VPC networks just like a virtual machine. In addition, it is ensured that the physical machine uses its own computing, storage, and other resources independently, eliminating the issue of multiple virtual machines sharing local resources of the physical machine, and thus turning the physical machine into a computing device having both the resilience from a virtual machine and the performance from a physical machine. In this way, the physical machine is highly isolated, and has both the migration advantages of the virtual machine and the resilient advantage of cloud deployment. In addition, it has the advantages of supporting rapid delivery, compatible virtual machine mirroring, cloud storage device startup, attachment of cloud storage devices, migration recovery of physical machine failures, automated operation and maintenance, etc., thus having high application value.

Further, the virtualization acceleration device 104 of this embodiment further includes a programmable logic device. The programmable logic device can be an FPGA or CPLD, and the like. Based on the programmable logic device, hardware modules or devices of various functions can be implemented on the virtualization acceleration device 104 as needed. For example, the hardware modules or devices required for the virtualization acceleration device 104 can be implemented, and other hardware modules or devices required for the physical machine can also be implemented, In the following embodiments of the present disclosure, the process of implementing, on the programmable logic device, the virtualized peripheral controller for the physical machine is used as an example for illustration.

As shown in FIG. 4, the virtualized peripheral controllers 116 for the physical machine 102 are implemented on the virtualization acceleration device 104. The physical machine may identify these virtualized peripheral controllers 116 through the high-speed serial bus 106 between the physical machine and the virtualization acceleration device 104, and calls these virtualized peripheral controllers 116 to execute operations related to external devices (i.e., peripheral operations). These virtualized peripheral controllers 116 may capture the actions of corresponding external devices on the physical machine, monitor the status of the external devices, execute the operations related to the external devices, or process data related to the external devices.

As the Virtualized peripheral controllers 116 implemented on the virtualization acceleration device 104 may learn and participate in the related operations of the physical machine, these Virtualized peripheral controllers 116 can cooperate with the remote control device to remotely control the physical machine. For example, the remote control device may send a remote control message 118 to the virtualization acceleration device 104 through a network, wherein the remote control message 118 may vary depending on remote control requirements; and then, the processor 108 on the virtualization acceleration device 104 receives the remote control message 118 sent by the remote control device, and remotely control the physical machine through the virtualized peripheral controllers 116 according to the remote control message 118, detailed process of which is shown in FIG. 1a-FIG. 1d.

In some example embodiments of the present disclosure, the virtualization acceleration device 104 may be interconnected to the physical machine using PCI or PCIE. Compared to the physical machine, the virtualization acceleration device 104 can be regarded as a PCI or PCIE device mounted on the physical machine. Therefore, the virtualization acceleration device 104 has its own PCI or PCIE configuration space, which is used to store some description information of the virtualization acceleration device 104, such as the vendor ID, device ID, class code, interrupt pins, and other important information. On this basis, the process of implementing the virtualized peripheral controller 116 on the virtualization acceleration device 104, for example, includes: configuring registers required for the peripheral controller on the virtualization acceleration device 104, and mapping the registers to a PCI or PCIE configuration space of the virtualization acceleration device 104 to implement the virtualized peripheral controller 116. Accordingly, the process that the physical machine identifies the virtualized peripheral controller 116, for example, includes: enumerating the devices on the high-speed serial bus, with the virtualization acceleration device 104 being identified first. Further, if the virtualization acceleration device 104 is discovered, the virtualized peripheral controller 116 implemented on the virtualization acceleration device 104 may be identified according to values of at least some of the registers in its configuration space, and the driver of the virtualized peripheral controller 116 is started.

When external devices supported by the physical machine are different, the virtualized peripheral controllers 116 implemented on the virtualization acceleration device 104 in this embodiment may also be different. In an example embodiment, the physical machine is provided with an external input device; the virtualized peripheral controller 116 implemented on the virtualization acceleration device 104 may then include a first peripheral controller corresponding to the external input device. In this example embodiment, the remote control device may remotely control the physical machine in relation to the external inputs, so it may send, to the virtualization acceleration device 104, a remote control message 118, which includes control actions related to the external inputs. After receiving the remote control message 118, the processor 108 on the virtualization acceleration device 104 provides the remote control message 118 to the first peripheral controller; the first peripheral controller reports the remote control message 118 to the physical machine through a PCI or PCIE bus. For the physical machine, specifically the operating system on the physical machine, may execute operations related to the external inputs according to the remote control message 118 reported by the first peripheral controller.

In this embodiment, the manner in which the processor 108 provides the remote control message 118 to the first peripheral controller is not limited. In an example embodiment, as shown in FIG. 4, the virtualization acceleration device 104 further includes a shared memory 110. The shared memory 110 may be shared by the first peripheral controller and the processor 108. In other words, the processor 108 can write the remote control message 118 sent by the remote control device into the shared memory 110, and the first peripheral controller can read the remote control message 118 from the shared memory 110.

For example, the external input device of the physical machine may include at least one of a keyboard, a mouse, and a touch screen. Depending on the external input devices, the first peripheral controller may also vary. If the external input device is a keyboard, the first peripheral controller can be implemented as a PCI- or PCIE-based keyboard controller; further, for example, if the keyboard is connected to the physical machine using a PS2 interface, the PCI- or PCIE-based keyboard controller can be implemented as a PCI- or PCIE-based PS2 keyboard controller, referred to as a PCI/PCIE-PS2 keyboard controller. The PCI/PCIE-PS2 keyboard controller is used as an example for illustration in FIG. 4.

If the external input device is a mouse, the first peripheral controller can be implemented as a PCI- or PCIE-based mouse controller; further, for example, if the mouse is connected to the physical machine using a PS2 interface, the PCI- or PCIE-based mouse controller can be implemented as a PCI- or PCIE-based PS2 mouse controller, referred to as a PCI/PCIE-PS2 mouse controller. The PCI/PCIE-PS2 mouse controller is used as an example for illustration in FIG. 4.

In an example embodiment, the physical machine is provided not only with an external input device, but also an external output device; the virtualized peripheral controller 116 implemented on the virtualization acceleration device 104 may then include a second peripheral controller corresponding to the external output device. The processor 108 is specifically configured to: receive a remote control message 118 sent by the remote control device, and read, from the memory of the second peripheral controller, the target data output by the external output device according to the remote control message 118; and provide the target data to the remote control device, such that the remote control device may locally output the target data, thus achieving synchronizing remote output information.

Further, for example, before sending the target data to the remote control device, the processor 108 may first write the target data into the shared memory 110 on the virtualization acceleration device 104 temporarily; then the target data is analyzed so that part of the data that has changed may be identified; and the part of data is sent to the remote control device such that the remote control device may update the target data to be locally output. This saves network resources as by transmitting only the incremental data that has changed each time, less data is involved. The shared memory 110 refers to a memory space on the virtualization acceleration device 104 and may be read and written by the processor 108 and the virtualized peripheral controller 116.

For example, the external output device of the physical machine may include at least one of a display, a speaker, or the like. If the external output device is a display, the second peripheral controller may be implemented as a PCI- or PCIE-based display controller; further, for example, if the display adopts the VGA display standard, the PCI- or PCIE-based display controller may be implemented as a PCI- or PCIE-based VGA controller, referred to as a PCI/PCIE-VGA controller. The PCI/PCIE-VGA controller is used as an example for illustration in FIG. 4.

In the embodiments of the present disclosure, how the hardware structure of the virtualization acceleration device 104 is implemented is not limited. For example, the virtualization acceleration device 104 may be implemented as a pluggable board structure, as shown in FIG. 1B and FIG. 1c. For example, the virtualization acceleration device 104 implemented as the board may include a first processing chip and a programmable logic device; the processor 108 and the shared memory 110 are implemented on the first processing chip; and the virtualized peripheral controller 116 is implemented on the programmable logic device, as shown in FIG. 1B. Alternatively, the virtualization acceleration device 104 may include a second processing chip; the processor 108, the shared memory 110, and the virtualized peripheral controller 116 are all implemented on the second processing chip, as shown in FIG. 1c. Alternatively, the virtualization acceleration device 104 may include a first processing chip and a third processing chip; the processor 108 and the shared memory 110 are implemented on the first processing chip; and the virtualized peripheral controller 116 is implemented on the third processing chip, as shown in FIG. 1d. Reference may be made to the aforementioned embodiments for the detailed description of FIG. 1B-FIG. 1d, which will not be repeated herein.

Based on the virtualization acceleration device 104 provided by this embodiment, the remote control device may remotely control the physical machine that is connected to the virtualization acceleration device 104 through a PCI or PCIE bus. Reference may be made to the aforementioned embodiments for the detailed process of remote control, which will not be repeated herein. Further, the remote control process may be implemented using the VNC technology, but is not limited thereto.

When the virtualization acceleration device 104 provided by this embodiment cooperates with the remote control device to implement the entire VNC process, the process does not rely on the BMC on the physical machine, or on private components developed by the physical machine vendor for interacting with the BMC, such as jviewer and iKVM components. Moreover, the virtualized peripheral controller directly interacts with the physical machine through the PCI or PCIE bus, and does not rely on the OOB data transmission protocol to interact with the BMC on the physical machine. In other words, the virtualization acceleration device according to the embodiments of the present disclosure can be used on all kinds of the physical machines provided by various vendors. When VNC is used, there is no need to acquire the desktop data 114 from the BMC of the physical machine or send the mouse/keyboard events to the BMC, avoiding the interaction with the private components jviewer/iKVM of the vendors, saving the workload of adapting to the private components of the vendors, making it more versatile.

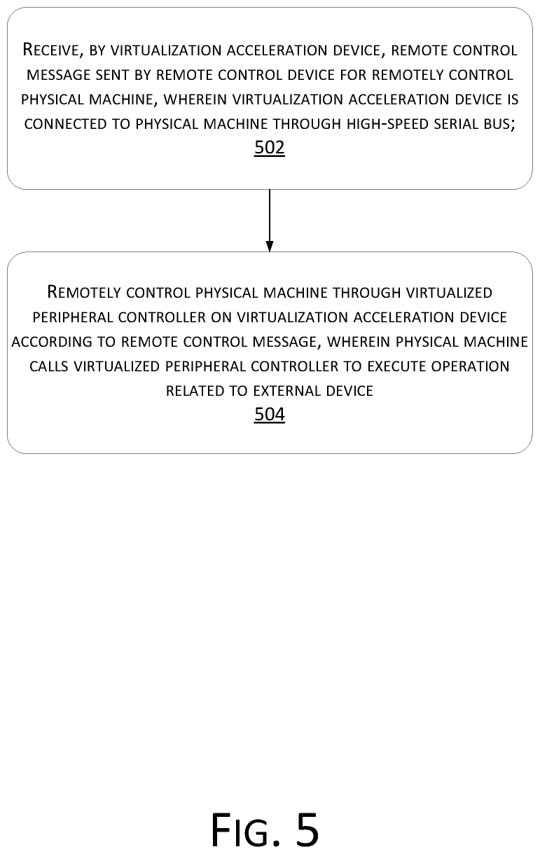

FIG. 5 is a schematic flow chart of a remote control method provided by an embodiment of the present disclosure. The method is applicable to the virtualization acceleration device of the embodiments shown in FIG. 1a-FIG. 1d, FIG. 2 or FIG. 4. As shown in FIG. 5, the method includes:
502, receiving, by a virtualization acceleration device, a remote control message 118 sent by a remote control device for remotely controlling a physical machine, wherein the virtualization acceleration device is connected to the physical machine through a high-speed serial bus;
504, remotely controlling the physical machine through a virtualized peripheral controller on the virtualization acceleration device according to the remote control message 118, wherein the physical machine calls the virtualized peripheral controller to execute an operation related to an external device.

In an example embodiment, the virtualization acceleration device includes a first processing chip and a programmable logic device; the processor is implemented on the first processing chip; and the virtualized peripheral controller is implemented on the programmable logic device. Alternatively, the virtualization acceleration device may include a second processing chip; the processor and the virtualized peripheral controller are both implemented on the second processing chip. Alternatively, the virtualization acceleration device may include a first processing chip and a third processing chip; the processor is implemented on the first processing chip; and the virtualized peripheral controller is implemented on the third processing chip. Specifically, registers required for the peripheral controller can be configured on the virtualization acceleration device (such as the programmable logic device, the second processing chip, or the third processing chip), and are mapped to the configuration space of the virtualization acceleration device to implement the virtualized peripheral controller.

In an example embodiment, the virtualized peripheral controller may include a first peripheral controller corresponding to an external input device of the physical machine. On this basis, the remotely controlling the physical machine through a virtualized peripheral controller on the virtualization acceleration device according to the remote control message 118 comprises: providing the remote control message 118 to the first peripheral controller, wherein the first peripheral controller reports the remote control message 118 to the physical machine such that the physical machine may execute an operation adapted to the external input device according to the remote control message 118.

Further, for example, the providing the remote control message 118 to the first peripheral controller comprises: writing the remote control message 118 into a shared memory on the virtualization acceleration device to be read by the first peripheral controller. Accordingly, the first peripheral controller reporting the remote control message 118 to the physical machine comprises: reading the remote control message 118 from the shared memory and reporting to the physical machine through the high-speed serial bus.

In an example embodiment, the virtualized peripheral controller may include a second peripheral controller corresponding to an external output device of the physical machine. On this basis, the remotely controlling the physical machine through a virtualized peripheral controller on the virtualization acceleration device according to the remote control message 118 comprises:
reading, from a memory of the second peripheral controller, target data output by the external output device according to the remote control message 118; and
sending the target data to the remote control device such that the remote control device may locally output the target data.

Further, for example, the sending the target data to the remote control device such that the remote control device may locally output the target data comprises:
writing the target data into the shared memory on the virtualization acceleration device, and identifying at least part of data that has changed in the target data; and
sending the at least part of data to the remote control device such that the remote control device may update the target data to be locally displayed.

Reference may be made to the aforementioned embodiments for the detailed description of each step of the above method embodiments, which will not be repeated herein.

It should be noted that the execution body in each step of the method provided in the embodiment may be the same device, or the method may use different devices as execution bodies. For example, the execution body of step 502 to step 504 can be a device A. For another example, the execution body of step 502 can be a device A, the execution body of step 504 can be a device B, etc.

In addition, in some of the processes described in the embodiments and accompany drawings, multiple operations shown in a specific order are included. It is to be understood that these operations may be performed not in the order in which they occur herein or may be performed in parallel. Step numbers of the operations, such as 501 and 502, are merely used to distinguish different operations. The numbers themselves do not represent any execution order. In addition, these processes may include more or fewer operations, and these operations may be performed sequentially or in parallel. It should be noted that the description of “first,” “second,” and the like herein is configured to distinguish different messages, devices, modules, and the like, and does not represent a sequence, nor does it define that “first” and “second” are different types.

Accordingly, embodiments of the present disclosure further provide a computer-readable storage medium having stored therein a computer program/instruction, wherein when the computer program/instruction is executed by a processor, the processor is enabled to implement steps in the above method embodiments.

Accordingly, embodiments of the present disclosure further provides a computer program product, comprising a computer program/instruction. When the computer program/instruction is executed by a processor, the processor is enabled to implement steps in the above method embodiments.

The display in the above embodiments includes a screen, which may be a liquid crystal display (LCD) and a touch panel (TP). If the screen includes a touch panel, the screen may be implemented as a touch screen to receive input signals from a user. The touch panel includes one or more touch sensors to sense touch, swiping, and gestures on the touch panel. The touch sensor may sense the boundary of a touch or swipe action, and it may further detect the duration and pressure related to the touch or swipe operation.

An audio component in the above embodiments may be configured to output and/or input audio signals. For example, the audio component may include a microphone (MIC) configured to receive an external audio signal when the device on which the audio component is located is in an operating mode, for example, in a call mode, a recording mode, or a voice recognition mode. The received audio signal may be further stored in a memory or sent through a communication component. In some embodiments, the audio component further includes a speaker for outputting an audio signal.

Those skilled in the art should understand that the embodiments of the present disclosure may be provided as a method, a system, or a computer program product. Therefore, the present disclosure may take a form of an entirely hardware embodiment, an entirely software embodiment, or an embodiment combining software and hardware elements. Furthermore, the present disclosure may take the form of a computer program product which is embodied on one or more computer-usable storage media (including, but not limited to, disk storage, CD-ROM, optical storage, and so forth) having computer-usable program code included therein.

The present disclosure is described with reference to flow charts and/or block diagrams of methods, devices (systems), and computer program products according to embodiments of the present disclosure. It should be understood that computer program instructions may be used to implement each process and/or each block in the flow charts and/or the block diagrams and a combination of a process and/or a block in the flow charts and/or the block diagrams. These computer program instructions may be provided for a general-purpose computer, a dedicated computer, an embedded processor, or a processor of another programmable data processing device to generate a machine, so that the instructions executed by a computer or a processor of another programmable data processing device generate an apparatus for implementing a specific function in one or more processes in the flow charts and/or in one or more blocks in the block diagrams.

These computer program instructions may also be stored in a computer readable memory that can instruct the computer or another programmable data processing device to work in a specific manner, so that the instructions stored in the computer readable memory generate an artifact that includes an instruction apparatus. The instruction apparatus implements a specific function in one or more processes in the flow charts and/or in one or more blocks in the block diagrams.

These computer program instructions may also be loaded onto a computer or another programmable data processing device, so that a series of operation steps are performed on the computer or another programmable device to generate computer-implemented processing. Therefore, the instructions executed on the computer or another programmable device are used to provide steps for implementing a specific function in one or more processes in the flow charts and/or in one or more blocks in the block diagrams.

In a typical configuration, a computing device includes one or more processors (CPU), an input/output interface, a network interface, and a memory.

The memory may include a volatile memory on a computer-readable medium, a random access memory (RAM) and/or a non-volatile memory, and the like, such as a read-only memory (ROM) or a flash random access memory (flash RAM). The memory is an example of the computer-readable media.

Computer-readable media further include nonvolatile and volatile, removable and non-removable media employing any method or technique to achieve information storage. The information may be computer-readable instructions, data structures, modules of programs, or other data. Examples of computer storage media include, but are not limited to, a phase-change random access memory (PRAM), a static random access memory (SRAM), a dynamic random access memory (DRAM), other types of random access memories (RAM), a read-only memory (ROM), an electrically erasable programmable read-only memory (EEPROM), a flash memory or other memory technologies, a compact disc read-only memory (CD-ROM), a digital versatile disc (DVD) or other optical memories, a magnetic cassette tape, a magnetic tape, a magnetic disk storage or other magnetic memories or any other non-transmission medium, which may be used to store information that can be accessed by a computing device. As defined herein, the computer-readable media do not include transitory media, such as modulated data signals and carriers.

It should be further noted that the terms “include,” “comprise,” or any other variants thereof are intended to encompass non-exclusive inclusion, so that a process, method, product, or device that involves a series of elements comprises not only those elements, but also other elements not explicitly listed, or elements that are inherent to such a process, method, product, or device. Without further limitation, an element defined by the phrase “including a . . . ” does not exclude the existence of another identical element in the process, method, product, or device that includes the element.

The above are only embodiments of the present disclosure and are not intended to limit the present disclosure. For those skilled in the art, there may be various modifications and changes to the present disclosure. Any modification, equivalent substitution, improvement, etc., made within the spirit and principle of the present disclosure shall be included in the scope of the claims of the present disclosure.

The present disclosure may further be understood with clauses as follows.

Clause 1. A computing device, comprising a physical machine and a virtualization acceleration device, wherein the virtualization acceleration device is connected to the physical machine through a high-speed serial bus;
a virtualized peripheral controller for the physical machine is implemented on the virtualization acceleration device, configured for cooperating with a remote control device to remotely control the physical machine;
the physical machine is configured to identify the virtualized peripheral controller and call the virtualized peripheral controller to execute a peripheral operation, wherein the peripheral operation corresponds to the remote control.

Clause 2. The device according to clause 1, wherein registers required for the peripheral controller are configured on the virtualization acceleration device, and the registers are mapped to a configuration space of the virtualization acceleration device to implement the virtualized peripheral controller.

Clause 3. The device according to clause 2, wherein the physical machine is specifically configured to: enumerate devices on the high-speed serial bus, and identify the virtualized peripheral controller according to values of at least some of the registers in the configuration space when the virtualization acceleration device is discovered.

Clause 4. The device according to any one of clauses 1-3, wherein the virtualization acceleration device further comprises a processor; and the processor is configured to remotely control the physical machine through the virtualized peripheral controller according to a remote control message sent by the remote control device.

Clause 5. The device according to clause 4, wherein the virtualized peripheral controller comprises a first peripheral controller corresponding to an external input device of the physical machine, and the processor is specifically configured to: provide the remote control message to the first peripheral controller such that the first peripheral controller may report same to the physical machine;
the physical machine is specifically configured to: execute an operation adapted to the external input device according to the remote control message reported by the first peripheral controller.

Clause 6. The device according to clause 5, wherein the processor is specifically configured to: write the remote control message into a shared memory on the virtualization acceleration device to be read by the first peripheral controller;
the first peripheral controller is configured to: read the remote control message from the shared memory and report to the physical machine through the high-speed serial bus, wherein the shared memory is a memory space on the virtualization acceleration device and may be read and written by the processor and the virtualized peripheral controller.

Clause 7. The device according to clause 5, wherein the external input device comprises at least one of a keyboard, a mouse, and a touch screen;
accordingly, the first peripheral controller comprises at least one of a keyboard controller, a mouse controller, and a touch screen controller; and
accordingly, the remote control message comprises at least one of a keyboard event, a mouse event, and touch action information.

Clause 8. The device according to clause 7, wherein if the remote control message comprises a mouse event, then the physical machine is specifically configured to: execute a mouse click operation according to mouse position information and mouse click information of the mouse event;
and/or
if the remote control message comprises a keyboard event, then the physical machine is specifically configured to: determine a corresponding key according to a keyboard code of the keyboard event, and simulate a keyboard input operation corresponding to the key.

Clause 9. The device according to clause 4, wherein the virtualized peripheral controller comprises a second peripheral controller corresponding to an external output device of the physical machine, and the processor is specifically configured to: read, from a memory of the second peripheral controller, target data output by the external output device according to the remote control message, and send the target data to the remote control device such that the remote control device may locally output the target data.

Clause 10. The device according to clause 9, wherein the external output device is a display; the second peripheral controller is a display controller; the remote control message is a remote desktop request, and the target data is desktop data.

Clause 11. The device according to clause 10, wherein the physical machine is further configured to: call the display controller to perform display processing on the desktop data when the display controller is identified; the display controller is further configured to write the desktop data into a local memory;
the processor is specifically configured to: read the desktop data from the memory of the display controller according to the remote desktop request, and return the desktop data to the remote control device such that the remote control device may locally display the desktop data.

Clause 12. The device according to clause 9, wherein the processor is specifically configured to: write the target data into the shared memory on the virtualization acceleration device, identify a part of data that has changed in the target data, and send the part of data to the remote control device such that the remote control device may update the target data to be locally output, wherein the shared memory is a memory space on the virtualization acceleration device and may be read and written by the processor and the virtualized peripheral controller.

Clause 13. The device according to clause 4, wherein the virtualization acceleration device comprises a programmable logic device and a first processing chip, the virtualized peripheral controller is located on the programmable logic device, and the processor is located on the first processing chip.

Clause 14. The device according to clause 13, wherein the programmable logic device is an FPGA chip or a CPLD chip; the first processing chip is an ASIC chip or an SOC chip.

Clause 15. The device according to clause 4, wherein the virtualization acceleration device comprises a second processing chip, and the virtualized peripheral controller and the processor are both located on the second processing chip.

Clause 16. The device according to clause 15, wherein the second processing chip is an ASIC chip or an SOC chip.

Clause 17. The device according to any one of clauses 1-3, wherein the high-speed serial bus is a PCI bus or a PCIE bus.

Clause 18. A virtualization acceleration device, comprising a high-speed serial bus and a virtualized peripheral controller implemented for a physical machine, wherein the virtualization acceleration device is connected to the physical machine through the high-speed serial bus; the virtualized peripheral controller is configured to cooperate with a remote control device to remotely control the physical machine, wherein the physical machine calls the virtualized peripheral controller to execute a peripheral operation, and the peripheral operation corresponds to the remote control.

Clause 19. The device according to clause 18, wherein the virtualization acceleration device further comprises a processor; and the processor is configured to: implement, on the virtualization acceleration device, the virtualized peripheral controller for the physical machine, and remotely control the physical machine through the virtualized peripheral controller according to a remote control message sent by the remote control device.

Clause 20. The device according to clause 19, wherein the processor is specifically configured to: configure registers required for the peripheral controller on the virtualization acceleration device, and map the registers to a configuration space of the virtualization acceleration device to implement the virtualized peripheral controller.

Clause 21. The device according to clause 19 or 20, wherein the virtualized peripheral controller comprises a first peripheral controller corresponding to an external input device of the physical machine, and the processor is specifically configured to: provide the remote control message to the first peripheral controller; the first peripheral controller is configured to report the remote control message to the physical machine such that the physical machine may execute an operation adapted to an external input according to the remote control message.

Clause 22. The device according to clause 21, wherein the processor is specifically configured to: write the remote control message into a shared memory on the virtualization acceleration device to be read by the first peripheral controller;
the first peripheral controller is configured to: read the remote control message from the shared memory and report to the physical machine through the high-speed serial bus, wherein
the shared memory is a memory space on the virtualization acceleration device and may be read and written by the processor and the virtualized peripheral controller.

Clause 23. The device according to clause 19 or 20, wherein the virtualized peripheral controller comprises a second peripheral controller corresponding to an external output device of the physical machine, and the processor is specifically configured to: read, from a memory of the second peripheral controller, target data output by the external output device according to the remote control message, and send the target data to the remote control device such that the remote control device may locally output the target data.

Clause 24. The device according to clause 23, wherein the processor is specifically configured to: write the target data into the shared memory on the virtualization acceleration device, identify at least part of data that has changed in the target data, and send the at least part of data to the remote control device such that the remote control device may update the target data to be locally output, wherein
the shared memory is a memory space on the virtualization acceleration device and may be read and written by the processor and the virtualized peripheral controller.

Clause 25. The device according to clause 19 or 20, wherein the virtualization acceleration device comprises a programmable logic device and a first processing chip, the virtualized peripheral controller is located on the programmable logic device, and the processor is located on the first processing chip.

Clause 26. The device according to clause 25, wherein the programmable logic device is an FPGA chip or a CPLD chip; the first processing chip is an ASIC chip or an SOC chip.

Clause 27. The device according to clause 19 or 20, wherein the virtualization acceleration device comprises a second processing chip, and the virtualized peripheral controller and the processor are both located on the second processing chip.

Clause 28. A remote control method, comprising:
receiving, by a virtualization acceleration device, a remote control message sent by a remote control device for remotely controlling a physical machine, wherein the virtualization acceleration device is connected to the physical machine through a high-speed serial bus; and
remotely controlling the physical machine through a virtualized peripheral controller on the virtualization acceleration device according to the remote control message, wherein the physical machine calls the virtualized peripheral controller to execute a peripheral operation, and the peripheral operation corresponds to the remote control.

Clause 29. The method according to clause 28, wherein the virtualized peripheral controller comprises a first peripheral controller corresponding to an external input device of the physical machine;
the remotely controlling the physical machine through a virtualized peripheral controller on the virtualization acceleration device according to the remote control message comprises:
providing the remote control message to the first peripheral controller, wherein the first peripheral controller reports the remote control message to the physical machine such that the physical machine may execute an operation adapted to the external input device according to the remote control message.

Clause 30. The method according to clause 29, wherein the providing the remote control message to the first peripheral controller comprises: writing the remote control message into a shared memory on the virtualization acceleration device to be read by the first peripheral controller;
accordingly, the first peripheral controller reporting the remote control message to the physical machine comprises: reading the remote control message from the shared memory and reporting to the physical machine through the high-speed serial bus.

Clause 31. The method according to clause 28, wherein the virtualized peripheral controller comprises a second peripheral controller corresponding to an external output device of the physical machine;
the remotely controlling the physical machine through a virtualized peripheral controller on the virtualization acceleration device according to the remote control message comprises:
reading, from a memory of the second peripheral controller, target data output by the external output device according to the remote control message; and
sending the target data to the remote control device such that the remote control device may locally output the target data.

Clause 32. The method according to clause 31, wherein the sending the target data to the remote control device such that the remote control device may locally output the target data comprises:
writing the target data into the shared memory on the virtualization acceleration device, and identifying at least part of data that has changed in the target data; and
sending the at least part of data to the remote control device such that the remote control device may update the target data to be locally displayed.

Clause 33. A computer-readable storage medium having stored therein a computer program/instruction, wherein when the computer program/instruction is executed by a processor, the processor is enabled to implement the method steps of any one of clauses 28-32.

Clause 34. A computer program product, comprising computer programs/instructions, wherein when the computer programs/instructions are executed by a processor, the processor is enabled to implement the method steps of any one of clauses 28-32.

What is claimed is:

1. A computing device comprising:
a virtualization acceleration device, the virtualization acceleration device being connected to a physical machine, a virtualized peripheral controller for the physical machine being implemented on the virtualization acceleration device for cooperating with a remote control device to conduct a remote control of the physical machine.

2. The computing device according to claim 1, wherein:
the physical machine identifies the virtualized peripheral controller and calls the virtualized peripheral controller to execute a peripheral operation, wherein the peripheral operation corresponds to the remote control; and
the virtualization acceleration device is connected to a physical machine through a high-speed serial bus.

3. The computing device according to claim 1, wherein:
the virtualization acceleration device includes one or more registers for a peripheral controller; and
the one or more registers are mapped to a configuration space of the virtualization acceleration device to implement the virtualized peripheral controller.

4. The computing device according to claim 3, wherein:
the physical machine enumerates one or more devices on a high-speed serial bus between the virtualization acceleration device and the physical machine, and identifies the virtualized peripheral controller according to values of at least some of the one or more registers in the configuration space.

5. The computing device according to claim 1, wherein:
the virtualization acceleration device further comprises a processor; and
the processor remotely controls the physical machine through the virtualized peripheral controller according to a remote control message sent by the remote control device.

6. The computing device according to claim 5, wherein:
the virtualized peripheral controller comprises a first peripheral controller corresponding to an external input device of the physical machine;
the processor provides the remote control message to the first peripheral controller such that the first peripheral controller reports the remote control message to the physical machine; and
the physical machine executes an operation adapted to the external input device according to the remote control message reported by the first peripheral controller.

7. The computing device according to claim 6, wherein:
the processor writes the remote control message into a shared memory on the virtualization acceleration device to be read by the first peripheral controller;
the first peripheral controller reads the remote control message from the shared memory and reports to the physical machine through a high-speed serial bus,
wherein the shared memory is a memory space on the virtualization acceleration device and is read and written by the processor and the virtualized peripheral controller.

8. The computing device according to claim 6, wherein:
the external input device comprises at least one of a keyboard, a mouse, and a touch screen;
the first peripheral controller comprises at least one of a keyboard controller, a mouse controller, and a touch screen controller; and
the remote control message comprises at least one of a keyboard event, a mouse event, and touch action information.

9. The computing device according to claim 8, wherein:
in response to determining that the remote control message comprises a mouse event, the physical machine executes a mouse click operation according to mouse position information and mouse click information of the mouse event; and
in response to determining that the remote control message comprises a keyboard event, the physical machine determines a key according to a keyboard code of the keyboard event, and simulates a keyboard input operation corresponding to the key.

10. The computing device according to claim 5, wherein:
the virtualized peripheral controller comprises a second peripheral controller corresponding to an external output device of the physical machine; and
the processor reads, from a memory of the second peripheral controller, target data output by the external output device according to the remote control message, and sends the target data to the remote control device to locally output the target data.

11. The computing device according to claim 10, wherein:
the external output device is a display;
the second peripheral controller is a display controller;
the remote control message is a remote desktop request; and
the target data is desktop data.

12. The computing device according to claim 11, wherein:
the physical machine calls the display controller to perform display processing on the desktop data in response to determining that the display controller is identified;
the display controller writes the desktop data into a local memory; and
the processor reads the desktop data from the memory of the display controller according to the remote desktop request, and returns the desktop data to the remote control device to locally display the desktop data.

13. The computing device according to claim 10, wherein:
the processor writes the target data into a shared memory on the virtualization acceleration device, identifies a part of data that has changed in the target data, and sends the part of data to the remote control device to update the target data to be locally output; and
the shared memory is a memory space on the virtualization acceleration device and is read and written by the processor and the virtualized peripheral controller.

14. The computing device according to claim 5, wherein:
the virtualization acceleration device comprises a programmable logic device and a first processing chip;
the virtualized peripheral controller is located on the programmable logic device; and
the processor is located on the first processing chip.

15. The computing device according to claim 5, wherein:
the virtualization acceleration device comprises a second processing chip, and
the virtualized peripheral controller and the processor are both located on the second processing chip.

16. A method comprising:
receiving, by a virtualization acceleration device, a remote control message sent by a remote control device for conducting a remote control of a physical machine; and
remotely controlling the physical machine through a virtualized peripheral controller on the virtualization acceleration device according to the remote control message.

17. The method of claim 16, wherein:
the physical machine calls the virtualized peripheral controller to execute a peripheral operation;
the peripheral operation corresponds to the remote control;
the virtualized peripheral controller comprises a first peripheral controller corresponding to an external input device of the physical machine; and
the remotely controlling the physical machine through a virtualized peripheral controller on the virtualization acceleration device according to the remote control message comprises providing the remote control message to the first peripheral controller, wherein the first peripheral controller reports the remote control message to the physical machine to execute an operation adapted to the external input device according to the remote control message.

18. The method according to claim 17, wherein:
the providing the remote control message to the first peripheral controller comprises writing the remote control message into a shared memory on the virtualization acceleration device to be read by the first peripheral controller; and
the first peripheral controller reporting the remote control message to the physical machine comprises reading the remote control message from the shared memory and reporting to the physical machine through a high-speed serial bus.

19. The method according to claim 16, wherein:
the virtualized peripheral controller comprises a second peripheral controller corresponding to an external output device of the physical machine; and
the remotely controlling the physical machine through a virtualized peripheral controller on the virtualization acceleration device according to the remote control message comprises:
reading, from a memory of the second peripheral controller, target data output by the external output device according to the remote control message; and
sending the target data to the remote control device such that the remote control device may locally output the target data.

20. One or more memories storing thereon computer-readable instructions that, when executed by one or more processors, cause the one or more processors to perform acts comprising:
receiving, by a virtualization acceleration device, a remote control message sent by a remote control device for conducting a remote control of a physical machine; and
remotely controlling the physical machine through a virtualized peripheral controller on the virtualization acceleration device according to the remote control message.
